(19) United States
(12) Patent Application Publication
(10) Pub. No.: US 2020/0184948 A1
(43) Pub. Date: Jun. 11, 2020

(54) SPEECH PLAYING METHOD, AN INTELLIGENT DEVICE, AND COMPUTER READABLE STORAGE MEDIUM

(71) Applicant: BAIDU ONLINE NETWORK TECHNOLOGY (BEIJING) CO., LTD., Beijing (CN)

(72) Inventors: Lingjin XU, Beijing (CN); Yongguo KANG, Beijing (CN); Yangkai XU, Beijing (CN); Ben XU, Beijing (CN); Haiguang YUAN, Beijing (CN); Ran XU, Beijing (CN)

(21) Appl. No.: 16/616,611

(22) PCT Filed: Jul. 2, 2018
(86) PCT No.: PCT/CN2018/094116

§ 371 Date: Nov. 25, 2019

(30) Foreign Application Priority Data
Jul. 5, 2017 (CN) 201710541569.2

(51) Int. Cl. G10L 13/04; G10L 13/10

(52) U.S. Cl. CPC G10L 13/043; G10L 13/10

(57) ABSTRACT

The present disclosure provides a speech playing method, an intelligent device and a computer readable storage medium. The method includes obtaining an object to be played; recognizing a target object type of the object to be played; obtaining a playing label set matching with the object to be played based on the target object type; in which, the playing label set is configured to represent playing rules of the object to be played; and playing the object to be played based on the playing rules represented by the playing label set.

### CROSS REFERENCE TO RELATED APPLICATIONS

This application is a US national phase of International Application No. PCT/CN2018/094116 filed on Jul. 2, 2018, which claims priority to Chinese Patent Application No. 201710541569.2, filed on Jul. 5, 2017.

### FIELD

The present disclosure relates to a field of speech processing technologies, and more particularly to a speech playing method and a speech playing device.

### BACKGROUND

With the growth of speech interaction products, speech playing effect attracts user' attention. At present, real-person speech playing may satisfy user's expectation and convey emotion. However, the real-person speech playing has high labor cost.

In order to reduce the labor cost, a Text-To-Speech (TTS) way is employed to play content or information to be played.

### SUMMARY

A first aspect of embodiments of the present disclosure provides a speech playing method, including: obtaining an object to be played; recognizing a target object type of the object to be played; obtaining a playing label set matching with the object to be played based on the target object type; in which, the playing label set is configured to represent playing rules of the object to be played; and playing the object to be played based on the playing rules represented by the playing label set.

A second aspect of embodiments of the present disclosure provides an intelligent device, including: a memory and a processor. The processor is configured to operate programs corresponding to executable program codes by reading the executable program codes stored in the memory, to implement the speech playing method the according to the first aspect of embodiments of the present disclosure.

A third aspect of embodiments of the present disclosure provides a computer readable storage medium having stored computer programs thereon. The computer program is configured to be executed by a processor to implement the speech playing method according to the first aspect of embodiments of the present disclosure.

Additional aspects and benefits of the present disclosure will be given in part in the following description, and will become apparent in part from the description below, or be known through the practice of the present disclosure.

### BRIEF DESCRIPTION OF THE DRAWINGS

In order to more clearly illustrate technical solutions in embodiments of the present disclosure, a brief description is made to accompanying drawings needed in embodiments below. Obviously, the accompanying drawings in the following descriptions are some embodiments of the present disclosure, and for those skilled in the art, other accompanying drawings may be obtained according to these accompanying drawings without creative labor.

FIG. 1 is a flow chart illustrating a speech playing method provided by an embodiment of the present disclosure.

FIG. 2 is a flow chart illustrating a speech playing method provided by another embodiment of the present disclosure.

FIG. 3 is a flow chart illustrating a speech playing method provided by another embodiment of the present disclosure.

FIG. 4 is a block diagram illustrating a speech playing device provided by an embodiment of the present disclosure.

FIG. 5 a block diagram illustrating a speech playing device provided by another embodiment of the present disclosure.

FIG. 6 is a schematic diagram illustrating an intelligent device provided by an embodiment of the present disclosure.

### DETAILED DESCRIPTION

Description will be made in detail below to embodiments of the present disclosure. Examples of embodiments are illustrated in the accompanying drawings, in which, the same or similar numbers represent the same or similar elements or elements with the same or similar functions. Embodiments described below with reference to the accompanying drawings are exemplary, which are intended to explain the present disclosure and do not be understood a limitation of the present disclosure.

Description is made below to a speech playing method and a speech playing device in the present disclosure with reference to the accompanying drawings.

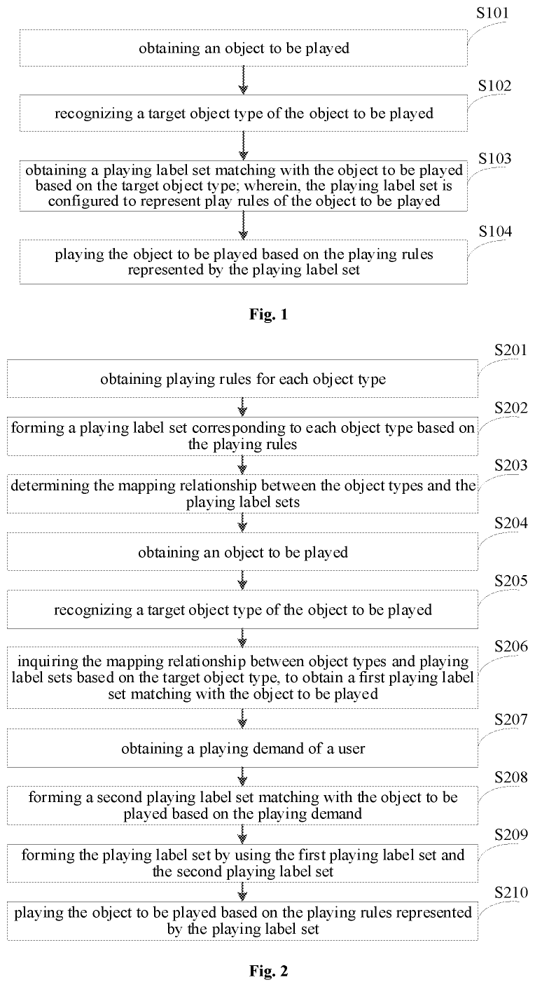

FIG. 1 is a flow chart illustrating a speech playing method provided by an embodiment of the present disclosure.

As illustrated to FIG. 1, the speech playing method may include acts in following blocks.

In block S101, an object to be played is obtained.

In one or more embodiments of the present disclosure, the object to be played is content or information that needs to be played.

Alternatively, a related application (APP) in an electronic device may be employed to obtain the object to be played, to play the object to be played, such as Baidu APP. After launching the related application installed in the electronic device, a user may determine the content or information that needs to be played through speech/character.

The electronic device is such as a Personal Computer (PC), a cloud device or a mobile device. The mobile device is such as an intelligent phone or a table computer.

For example, it is assumed that the related application installed in the electronic device is Baidu APP. When wanting to feel emotion carried by the object to be played by hearing, the user may click an icon of Baidu APP to enter a surface of Baidu APP, and hold the button “holding to speak” long in the surface for inputting speeches. After inputting a speech “Duer (another addition to the family of virtual assistants, which is developed by Baidu)”, a “Duer” plugin may be entered, such that the user may determine the content or information to be played by inputting speech/character, and then the “Duer” plugin may obtain the content/information that needs to be played, that is, the object to be played is obtained.

In block S102, a target object type of the object to be played is recognized.

Since the object to be played varies with the object type, and the object type varies with the playing rules, the target object type of the object to be played needs to be recognized before playing the object to be played, to select matched playing rules to play the object to be played based on the target object type.

Alternatively, the target object type of the object to be played may be recognized based on key information of the object to be played. For example, the object type may be poetry, weather, time, calculation and the like.

The key information of the object to be played may be such as a source (an application) of the object to be played, or may be a title of the object to be played, or may be an identification code of the object to be recognized, which is not limited here.

In block S103, a playing label set matching with the object to be played is obtained based on the target object type; in which, the playing label set is configured to represent playing rules of the object to be played.

Since the object type varies with the playing rules, the playing label set corresponding to the object type may be formed for the playing rules. And then, a mapping relationship between the object types and the playing label sets may be established in advance, and the mapping relationship between the object types and the playing label sets may be searched for when the target object type of the object to be played is determined, to obtain the playing label set matching with the object to be played from the mapping relationship.

The playing label set may include labels such as pause, stress, volume, tone, sound speed, sound source, audio input, polyphonic character identifier, digit reading identifier and the like.

A pause label: for realizing pauses on the time for a word level, a phrase level, a short sentence level and a full sentence level.

A stress label: for realizing different stress sizes.

A volume label, a tone label, a sound speed label, a thickness label: for realizing adjusting corresponding playing based on a percentage.

An audio input label: for inserting an audio file in a text.

A polyphonic character identifier label: for marking a correct reading of a polyphonic word.

A digit reading identifier label: for marking a correct reading of a digit, in which, the digit includes: an integer, a numeric string, a ratio, a score, a phone call number, a zip code, etc.

A sound source label: for selecting a pronunciation people.

For example, when the target object type is the poetry, as a traditional culture of the Chinese nation, the poetry has a unique phonology and temperament in reading aloud. Therefore, a playing label set marching with the poetry may be formed based on a reading rule of the poetry. Taking a five-character verse (which is a line from a poem with five characters to a line in Chinese literature) “ [symbol] (Chinese characters, which mean ‘in front of my bed the moonlight is very bright’)” as an example, a word-level pause may need to be marked after “ [symbol] (Chinese characters, which mean ‘in front of my bed’)” based on a reading rule of the five-character verse, and then the pause label is provided to present that a pause is performed after the two characters “ [symbol] ”, that is, the pause is performed after the second word; a character “ [symbol] (a Chinese character, which means ‘bright’)” needs to be stressed, and then the stress label is provided to present that a stress is performed on the character “ [symbol] ”, that is, the stress reading is performed on the third character; a character “ [symbol] (a Chinese character, which means ‘light’)” needs to read for a short extension duration, and then the sound speed label is provided to present that a short extension is performed on the character “ [symbol] ”, that is, the short extension is performed on the fifth character, and a playing time of the word “ [symbol] ” is extended. By adding the labels in the playing label set, “ [symbol] [symbol] ” is marked. Taking this as an example, a complete five-character verse may be marked, and the complete format is output finally, to synthesize the playing label set matching with the five-character verse. The playing label set includes the pause label of word-level, the stress label, the sound speech label and the like.

In block S104, the object to be played is played based on the playing rules represented by the playing label set.

Taking the five-character verse as an example, in a detailed application, when it is determined that the object type of the object to be played is the five-character verse, as long as the playing label set matching with the five-character verse is added, the five-character verse is played based on the playing rules represented by the playing label set, and the reading effect with full emotion and speech may be implemented.

With the speech playing method in embodiments of the present disclosure, the playing label set matching with the object to be played is obtained based on the target object type of the object to be played; in which, the playing label set is configured to represent the playing rules of the object to be played; and the object to be played is played based on the playing rules represented by the playing label set. In this embodiment, it may play emotion carried by content to be played to the audience during playing, such that the audience may feel the emotion carried by the content in hearing. In this embodiment, it is an implementation of speech Synthesis Markup Language (SSML) specification that the object is played based on the playing label set, which facilitates that people hear the speech by various terminal devices.

Further, embodiments of the present disclosure may further form a customized playing label according to a playing demand of the user. In detail, referring to FIG. 2, FIG. 2 is a flow chart illustrating a speech playing method provided by another embodiment of the present disclosure.

Referring to FIG. 2, the method may include acts in the following blocks.

In block S201, for each object type, the playing rules are obtained.

Since the object type varies with the playing rules, the playing rules under each object type are obtained in advance. For example, taking that the object type is the poetry as an example, the playing rules is the reading rules of the poetry.

In block S202, the playing label set corresponding to each object type is formed based on the playing rules.

For example, when the object type is the poetry, the playing label set marching with the poetry may be formed based on the reading rules of the poetry. Taking the five-character verse “ [symbol] ” as an example, a word-level pause may need to be marked after “ [symbol] (Chinese characters, which mean ‘in front of my bed’)” based on a reading rule of the five-character verse, and then the pause label is provided to present that a pause is performed after the two characters “ [symbol] ”, that is, the pause is performed after the second word; a character “ [symbol] (a Chinese character, which means ‘bright’)” needs to be stressed, and then the stress label is provided to present that a stress is performed on the character “ [symbol] ”, that is, the stress reading is performed on the third character; a character “ [symbol] (a Chinese character, which means ‘light’)” needs to read for a short extension duration, and then the sound speed label is provided to present that a short extension is performed on the character “ [symbol] ”, that is, the short extension is performed on the fifth character, and a playing time of the word “ [symbol] ” is extended. By adding the labels in the playing label set, “ [symbol] ” is marked. Taking this as an example, a complete five-character verse may be marked, and the complete format is output finally, to synthesize the playing label set matching with the five-character verse. The playing label set includes the pause label of word-level, the stress label, the sound speech label and the like.

In block S203, the mapping relationship between the object types and the playing label sets is determined.

Alternatively, the mapping relationship between the object types and the playing label sets is determined. When the target object type of the object to be played is determined, the mapping relationship may be searched for, and the playing label set matching with the object to be played is obtained from the mapping relationship, which is easy to be implemented and operated.

In block S204, the object to be played is obtained.

In block S205, the target object type of the object to be played is recognized.

In block S206, the mapping relationship between the object types and the playing label sets is inquired based on the target object type, to obtain a first playing label set matching with the object to be played.

The first playing label set may include labels such as pause, stress, volume, tone, sound speed, sound source, audio input, polyphonic character identifier, digit reading identifier and the like.

The execution procedures of block S204-S206 may refer to the above embodiments, which are not elaborated here.

In block S207, the playing demand of the user is obtained.

For example, it is assumed that the target object type is weather. When the weather is reported via speech, especially a rainy day, the playing demand of the user may be such as: a sound of raining is played during reporting the weather via speech, and the user may be prompted of going out with an umbrella; or when hail is reported via speech, the playing demand of the user may be such as: a sound of hail is played during reporting the weather via speech, and the user may be prompted of not going out.

In block S208, a second playing label set matching with the object to be played is formed based on the playing demand.

In one or more embodiments of the present disclosure, the second label set includes a background sound label, an English reading label, a poetry label, a speech emoji label, etc.

The background sound label: built based on the audio input label, and for combining an audio effect to the playing content.

The English reading label: similar with the polyphonic character identifier label, for distinguishing between reading by a letter and reading by the word.

The poetry label: for classify the poetry based on the poetry type and the tune title. In detail, for each class, the reading rules such as rhythm of each type may be marked, and a high level label of the poetry type may be generated by combining with the labels in the first playing label set.

The speech emoji label: an audio file library under different emotions and scenes may be built, and corresponding audio file sources in respective different scenes may be introduced, to generate a speech playing emoji. For example, when the weather is inquired, if the weather is rainy, a corresponding sound of raining is played.

For example, when the target object type is weather, the second playing label set matching with the objected to be played may be the background sound label. In a detailed application, the sound of raining or the sound of hail may be played while the weather is reported via speech by adding the background sound label.

As another example, when the object to be played is English, the second playing label set matching with the object to be played may be the English reading label. In a detailed application, the object to be played may be read wonderfully with a silver voice and deep feeling by adding the English reading label.

As still another example, when the target object type is the poetry, the second playing label set matching with the object to be played may be the poetry label. In a detailed application, the poetry may be read wonderfully with a silver voice and deep feeling by adding the poetry label.

In the act, the second playing label set matching with the object to be played is formed based on the playing demand of the user, enabling to implement a personalized customization of speech playing, which effectively improves an applicability of the speech playing method and improves user's experience.

In block S209, the playing label set is formed by using the first playing label set and the second playing label set.

Taking playing the poetry as an example, the first playing label set may be formed based on the reading rules, and the second playing label set matching with the playing demand is the poetry label, and then the playing label set is formed by using the first playing label set and the second playing label set.

Taking playing the weather as an example, the first playing label set may be obtained based on the content to be played, and the second playing label set matching with the playing demand is the background sound label, and then the playing label set is formed by using the first playing label set and the second playing label set. In detail, a single playing effect is implemented by adding the background sound label to a fixed play content. Different playing effects under different weathers are marked in turn, finally to generate the playing label set of the weather.

In block S210, the object to be played is played based on the playing rules represented by the playing label set.

Taking playing the weather as an example, when the weather is reported via speech, demand effects of different users may be played based on the playing label set of the weather and a weather keyword.

The execution procedure of block S210 may refer to the above embodiments, which is not elaborated here.

With the speech playing method in the embodiments, the playing rules for each object type are obtained, the playing label set corresponding to each object type is formed based on the playing rules, and the mapping relationship between the object types and the playing label sets is determined, which is easy to be implemented and operated. By obtaining the object to be played, recognizing the target object type of the object to be played, inquiring the mapping relationship between the object types and the playing label sets based on the target object type, to obtain the first playing label set matching with the object to be played, forming the second playing label set matching with the object to be played based on the playing demand, forming the playing label set by using the first target playing label set and the second target playing label set, and playing the object to be played based on the playing rules represented by the playing label set, it may implement the personalized customization of the speech playing, effectively improving the applicability of the speech playing method and improves the user's experience.

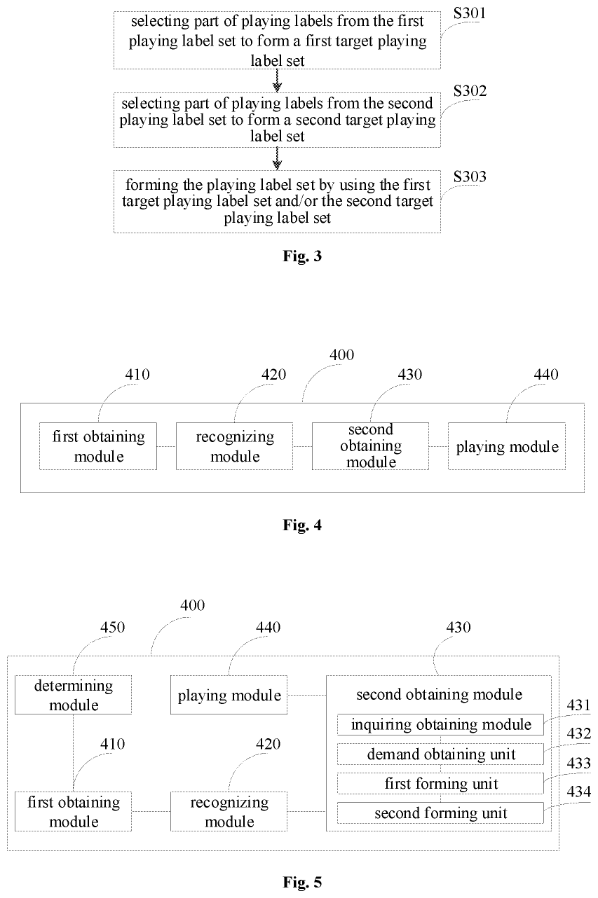

In order to illustrate the above embodiments in detail, referring to FIG. 3, on the basis of embodiments illustrated in FIG. 2, the act in block S209 includes acts in the following sub blocks in detail.

In sub block S301, part of playing labels are selected from the first playing label set to form a first target playing label set.

It should be understood that, the first playing label set may include pause, stress, volume, tone, sound speed, sound source, audio input, polyphonic character identifier, digit reading identifier and the like. Playing the object to be played may only employ part of labels in the first playing label. Therefore, in a detailed application, part of playing labels related to this playing may be selected from the first playing label set, to form the first target playing label set, which is highly targeted and improves the processing efficiency of the system.

In sub block S302, part of playing labels are selected from the second playing label set to form a second target playing label set

It should be understood that, the playing label set matching with the playing demand of the user may only contain certain playing labels in the second playing label set. For example, when the weather is reported via speech, the playing label set matching with the playing demand of the user is only the background sound label. Therefore, part of playing labels may be selected from the second playing label set, to form the second target playing label set, which is highly targeted and improves the processing efficiency of the system.

Taking playing the weather as an example, the background sound label is selected from the second playing label set to form the second target playing label set.

Taking playing the poetry as an example, the poetry label may be selected from the second playing label set to form the second target playing label set.

In sub block S303, the playing label set is formed by using the first target playing label set and/or the second target playing label set.

With the speech playing method in the embodiments, by selecting the part of playing labels from the first playing label set to form the first target playing label set, selecting part of playing labels from the second playing label set to form the second target playing label set, and forming the playing label set by using the first target playing label set and/or the second target playing label set, it may implement the personalized customization of the speech playing, which is highly targeted and improves the processing efficiency of the system.

In order to implement the above embodiments, the present disclosure further provides a speech playing device.

FIG. 4 is a block diagram illustrating a speech playing device provided by an embodiment of the present disclosure.

As illustrated in FIG. 4, the device 400 may include a first obtaining module 410, a recognizing module 420, a second obtaining module 430 and a playing module 440.

The first obtaining module 410 is configured to obtain an object to be played.

The recognizing module 420 is configured to recognize a target object type of the object to be played.

Further, the recognizing module 420 is configured to recognize the target object type of the object to be played based on key information of the object to be played.

The second obtaining module 430 is configured to obtain a playing label set matching with the object to be played based on the target object type; in which, the playing label set is configured to represent playing rules of the object to be played.

The playing module 440 is configured to play the object to be played based on the playing rules represented by the playing label set.

Further, in a possible implementation of embodiments of the present disclosure, on the basis of FIG. 4, referring to FIG. 5, the device 400 further includes: a determining module 450.

The determining module 450 is configured to obtain playing rules for each object type; form a playing label set corresponding to each object type based on the playing rules, and to determine the mapping relationship between the object types and the playing label sets.

In a possible implementation of embodiments of the present disclosure, the second obtaining module 430 includes an inquiring obtaining module 431, a demand obtaining unit 432, a first forming unit 433, and a second forming unit 434.

The inquiring obtaining module 431 is configured to inquire the mapping relationship between the object types and the playing label sets based on the target object type, to obtain a first playing label set matching with the object to be played, in which, the first playing label set is used as the playing label set.

The demand obtaining unit 432 is configured to obtain a playing demand of a user after inquiring the mapping relationship between the object types and the playing label sets based on the target object type to obtain the first playing label set matching with the object to be played.

The first forming unit 433 is configured to form a second playing label set matching with the object to be played based on the playing demand.

The second forming unit 434 is configured to form the playing label set by using the first playing label set and the second playing label set.

Further, the second forming unit 434 is configured to select part of playing labels from the first playing label set to form a first target playing label set; select part of playing labels from the second playing label set to form a second target playing label set; and form the playing label set by using the first target playing label set and/or the second target playing label set.

It should be noted that, the explanation and illustration for the speech playing method in the foregoing embodiments in FIG. 1-FIG. 3 are further applicable to the device 400 in the embodiments, which are not elaborated here.

With the speech playing device in the embodiment, the playing label set matching with the object to be played is obtained based on the target object type of the object to be played; in which, the playing label set is configured to represent the playing rules of the object to be played; and the object to be played is played based on the playing rules represented by the playing label set. In this embodiment, it may play emotion carried by content to be played to the audience during playing, such that the audience may feel the emotion carried by the content in hearing. In this embodiment, it is an implementation of speech Synthesis Markup Language specification that the object is played based on the playing label set, which facilitates that people hear the speech by various terminal devices.

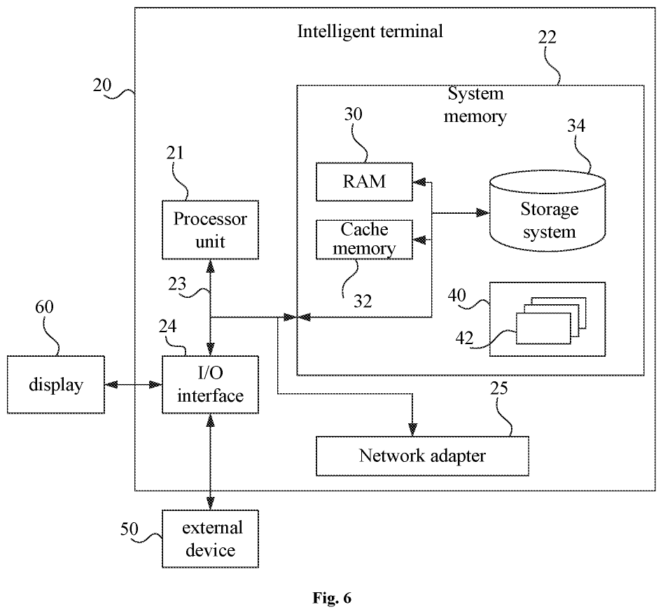

FIG. 6 is a block diagram illustrating an exemplary intelligent device 20 applied to implement implementations of the present disclosure. The intelligent device 20 illustrated in FIG. 6 is only an example, which may not bring any limitation to functions and scope of embodiments of the present disclosure.

As illustrated in FIG. 6, the intelligent device 20 is embodied in the form of a general-purpose computer device. Components of the intelligent device 20 may include but be not limited to: one or more processors or processing units 21, a system memory 22, and a bus 23 connecting different system components (including the system memory 22 and the processing unit 21).

The bus 23 represents one or more of several bus structures, including a storage bus or a storage controller, a peripheral bus, an accelerated graphics port, and a processor or a local bus of any bus structure in the plurality of bus structures. For example, these architectures include but are not limited to an ISA (Industry Standard Architecture) bus, a MAC (Micro Channel Architecture) bus, an enhanced ISA bus, a VESA (Video Electronics Standards Association) local bus and a PCI (Peripheral Component Interconnection) bus.

The intelligent device 20 typically includes various computer system readable mediums. These mediums may be any usable medium that may be accessed by the intelligent device 20, including volatile and non-volatile mediums, removable and non-removable mediums.

The system memory 22 may include computer system readable mediums in the form of volatile medium, such as a Random Access Memory (RAM) 30 and/or a cache memory 32. The intelligent device 20 may further include other removable/non-removable, volatile/non-volatile computer system storage mediums. Only as an example, the storage system 34 may be configured to read from and write to non-removable, non-volatile magnetic mediums (not illustrated in FIG. 6, which is usually called “a hard disk driver”). Although not illustrated in FIG. 6, a magnetic disk driver configured to read from and write to the removable non-volatile magnetic disc (such as “a floppy disk”), and an optical disc driver configured to read from and write to a removable non-volatile optical disc (such as a Compact Disc Read Only Memory (CD-ROM), a Digital Video Disc Read Only Memory (DVD-ROM) or other optical mediums) may be provided. Under these circumstances, each driver may be connected with the bus 23 by one or more data medium interfaces. The memory 22 may include at least one program product. The program product has a set of program modules (for example, at least one program module), and these program modules are configured to execute functions of respective embodiments of the present disclosure.

A program/utility tool 40, having a set (at least one) of program modules 42, may be stored in the memory 22. Such program modules 42 include but not limited to an operating system, one or more application programs, other program modules, and program data. Each or any combination of these examples may include an implementation of a networking environment. The program module 42 usually executes functions and/or methods described in embodiments of the present disclosure.

The intelligent device 20 may communicate with one or more external devices 50 (such as a keyboard, a pointing device, a display 60), may further communicate with one or more devices enabling a user to interact with the intelligent device 20, and/or may communicate with any device (such as a network card, and a modem) enabling the intelligent device 20 to communicate with one or more other computer devices. Such communication may occur via an Input/Output (I/O) interface 24. Moreover, the intelligent device 20 may further communicate with one or more networks (such as a Local Area Network (LAN), a Wide Area Network (WAN) and/or a public network, such as Internet) via a network adapter 25. As illustrated in FIG. 6, the network adapter 25 communicates with other modules of the intelligent device 20 via the bus 23. It should be understood that, although not illustrated in FIG. 6, other hardware and/or software modules may be used in combination with the intelligent device 20, including but not limited to: a microcode, a device driver, a redundant processing unit, an external disk drive array, a RAID (Redundant Array of Independent Disks) system, a tape drive, a data backup storage system, etc.

The processor 21, by operating programs stored in the system memory 22, executes various function applications and data processing, such as implementing the speech playing method illustrated in FIG. 1-FIG. 3.

Any combination of one or more computer readable mediums may be employed. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing contents. More specific examples (a non-exhaustive list) of the computer-readable storage media may include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical memory device, a magnetic memory device, or any of the above appropriate combinations. In this document, a computer readable storage medium can be any tangible medium that contains or stores a program. The program can be used by or in conjunction with an instruction execution system, apparatus or device.

The computer readable signal medium may include a data signal transmitted in the baseband or as part of a carrier, which carries computer readable program codes. The data signal transmitted may employ a plurality of forms, including but not limited to an electromagnetic signal, a light signal or any suitable combination thereof. The computer readable signal medium may further be any computer readable medium other than the computer readable storage medium. The computer readable medium may send, spread or transmit programs for use by or in combination by an instruction executing system, an apparatus or a device.

The program codes included in computer readable medium may be transmitted by any appropriate medium, including but not limited to wireless, wired, cable, RF (Radio Frequency), etc., or any suitable combination of the above.

The computer program codes for executing an operation of the present disclosure may be programmed by using one or more program languages or the combination thereof. The program language includes an object-oriented programming language, such as Java, Smalltalk, C++, further includes a conventional procedural programming language, such as a C programming language or a similar programming language. The computer program codes may execute entirely on the computer of the user, partly on the computer of the user, as a stand-alone software package, partly on the computer of the user and partly on a remote computer, or entirely on a remote computer or a server. In the scenario related to the remote computer, the remote computer may be connected to the user's computer through any type of network, including a local area network (LAN) or a wide area network (WAN), or be connected to an external computer (for example, through the Internet using an Internet Service Provider).

To achieve the above embodiments, the present disclosure further provides a computer program product. When instructions in the computer program product are configured to be executed by a processor, the method speech playing according to the foregoing embodiments is executed.

To achieve the above embodiments, the present disclosure further provides a computer readable storage medium having stored computer programs thereon. When the computer programs are configured to be executed by a processor, the speech playing method according to the foregoing embodiments may be executed.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, without a contradiction, the different embodiments or examples and the features of the different embodiments or examples can be combined by those skilled in the art.

In addition, the terms of “first”, “second” is only for description purpose, and it cannot be understood as indicating or implying its relative importance or implying the number of indicated technology features. Thus, features defined as “first”, “second” may explicitly or implicitly include at least one of the features. In the description of the present disclosure, “a plurality of” means at least two, such as two, three, unless specified otherwise.

Any procedure or method described in the flow charts or described in any other way herein may be understood to include one or more modules, portions or parts of executable instruction codes for implementing steps of a custom logic function or a procedure. And the scope of preferable embodiments of the present disclosure includes other implementation, where functions may be executed in either a basic simultaneous manner or in reverse order according to the functions involved, rather than in the order shown or discussed, which may be understood by the skilled in the art of embodiments of the present disclosure.

The logic and/or step described in other manners herein or shown in the flow chart, for example, may be considered to be a particular sequence table of executable instructions for realizing the logical function, may be specifically achieved in any computer readable medium to be used by the instruction execution system, device or equipment (such as a system based on computers, a system including processors or other systems capable of extracting the instruction from the instruction execution system, the device and the equipment and executing the instruction), [symbol] or to be used in combination with the instruction execution system, the device and the equipment. As to the specification, “the computer readable medium” may be any device adaptive for including, storing, communicating, propagating or transferring programs for use by or in combination with the instruction execution system, the device or the equipment. More specific examples (a non-exhaustive list) of the computer readable medium include: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that, respective parts of the present disclosure may be implemented with hardware, software, firmware or a combination thereof. In the above implementations, a plurality of steps or methods may be implemented by software or firmware that is stored in the memory and executed by an appropriate instruction executing system. For example, if it is implemented by hardware, it may be implemented by any one of the following technologies known in the art or a combination thereof as in another embodiment: a discrete logic circuit(s) having logic gates for implementing logic functions upon data signals, an Application Specific Integrated Circuit (ASIC) having appropriate combinational logic gates, a Programmable Gate Array(s) (PGA), a Field Programmable Gate Array (FPGA), etc.

The common technical personnel in the field may understand that all or some steps carried in the above embodiments may be completed by the means that relevant hardware is instructed by a program. The program may be stored in a computer readable storage medium, and the program includes any one or combination of the steps in embodiments when being executed.

In addition, respective function units in respective embodiments of the present disclosure may be integrated in a processing unit, may further exist physically alone, and may further be that two or more units integrated in a unit. The foregoing integrated unit may be implemented either in the forms of hardware or software. If the integrated module is implemented as a software functional module and is sold or used as a stand-alone product, it may further be stored in a computer readable storage medium.

The above-mentioned storage medium may be a ROM, a magnetic disk or a disk and the like. Although embodiments of the present disclosure have been shown and described above. It should be understood that, the above embodiments are exemplary, and it cannot be construed to limit the present disclosure, and those skilled in the art can make changes, alternatives, and modifications in the embodiments without departing from scope of the present disclosure.

1. A speech playing method, comprising:
obtaining an object to be played;
recognizing a target object type of the object to be played;
obtaining a playing label set matching with the object to be played based on the target object type; wherein, the playing label set is configured to represent playing rules of the object to be played; and
playing the object to be played based on the playing rules represented by the playing label set.

2. The method of claim 1, wherein, obtaining the playing label set matching with the object to be played based on the target object type, comprises:
inquiring a mapping relationship between object types and playing label sets based on the target object type, to obtain a first playing label set matching with the object to be played, in which, the first playing label set is used as the playing label set.

3. The method of claim 2, further comprising:
obtaining a playing demand of a user;
forming a second playing label set matching with the object to be played based on the playing demand; and
forming the playing label set by using the first playing label set and the second playing label set.

4. The method of claim 3, wherein, forming the playing label set by using the first playing label set and the second playing label set, comprises:
selecting part of playing labels from the first playing label set to form a first target playing label set;
selecting part of playing labels from the second playing label set to form a second target playing label set; and
forming the playing label set by using the first target playing label set and/or the second target playing label set.

5. The method of claim 1, further comprising:
obtaining playing rules for each object type;
forming a playing label set corresponding to each object type based on the playing rules; and
determining a mapping relationship between the object types and the playing label sets.

6. The method of claim 1, wherein, recognizing the target object type of the object to be played, comprises:
recognizing the target object type of the object to be played based on key information of the object to be played.

7-12. (canceled)

13. An intelligent device, comprising a memory and a processor, wherein, the processor is configured to operate programs corresponding to executable program codes by reading the executable program codes stored in the memory, to implement a speech playing method comprising:
obtaining an object to be played;
recognizing a target object type of the object to be played;
obtaining a playing label set matching with the object to be played based on the target object type; wherein, the playing label set is configured to represent playing rules of the object to be played; and
playing the object to be played based on the playing rules represented by the playing label set.

14. A non-transient computer readable storage medium having stored computer programs thereon, wherein, the computer program is configured to be executed by a processor to implement a speech playing method comprising:
obtaining an object to be played;
recognizing a target object type of the object to be played;
obtaining a playing label set matching with the object to be played based on the target object type; wherein, the playing label set is configured to represent playing rules of the object to be played; and
playing the object to be played based on the playing rules represented by the playing label set.

15. The intelligent device of claim 13, wherein, obtaining the playing label set matching with the object to be played based on the target object type, comprises:
inquiring a mapping relationship between object types and playing label sets based on the target object type, to obtain a first playing label set matching with the object to be played, in which, the first playing label set is used as the playing label set.

16. The intelligent device of claim 15, wherein, the method further comprises:
obtaining a playing demand of a user;
forming a second playing label set matching with the object to be played based on the playing demand; and
forming the playing label set by using the first playing label set and the second playing label set.

17. The intelligent device of claim 16, wherein, forming the playing label set by using the first playing label set and the second playing label set, comprises:
selecting part of playing labels from the first playing label set to form a first target playing label set;
selecting part of playing labels from the second playing label set to form a second target playing label set; and
forming the playing label set by using the first target playing label set and/or the second target playing label set.

18. The intelligent device of claim 13, wherein the method further comprises:
obtaining playing rules for each object type;
forming a playing label set corresponding to each object type based on the playing rules; and
determining a mapping relationship between the object types and the playing label sets.

19. The intelligent device of claim 13, wherein, recognizing the target object type of the object to be played, comprises:
recognizing the target object type of the object to be played based on key information of the object to be played.

20. The non-transient computer readable storage medium of claim 14, wherein, obtaining the playing label set matching with the object to be played based on the target object type, comprises:
inquiring a mapping relationship between object types and playing label sets based on the target object type, to obtain a first playing label set matching with the object to be played, in which, the first playing label set is used as the playing label set.

21. The non-transient computer readable storage medium of claim 20, wherein, the method further comprises:
obtaining a playing demand of a user;
forming a second playing label set matching with the object to be played based on the playing demand; and
forming the playing label set by using the first playing label set and the second playing label set.

22. The non-transient computer readable storage medium of claim 21, wherein, forming the playing label set by using the first playing label set and the second playing label set, comprises:
selecting part of playing labels from the first playing label set to form a first target playing label set;
selecting part of playing labels from the second playing label set to form a second target playing label set; and
forming the playing label set by using the first target playing label set and/or the second target playing label set.

23. The non-transient computer readable storage medium of claim 14, wherein the method further comprises:
obtaining playing rules for each object type;
forming a playing label set corresponding to each object type based on the playing rules; and
determining a mapping relationship between the object types and the playing label sets.

24. The non-transient computer readable storage medium of claim 14, wherein, recognizing the target object type of the object to be played, comprises:
recognizing the target object type of the object to be played based on key information of the object to be played.
